(19) United States
(12) Patent Application Publication
(10) Pub. No.: US 2006/0206446 A1
(43) Pub. Date: Sep. 14, 2006

(54) Personal information manager and communications application providing dynamic contact communication history

(75) Inventors: Scott Cowell, Redmond, WA (US); Nicholas James Thomson, Redmond, WA (US); Shannon Pahl, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 10/988,988

(22) Filed: Mar. 14, 2005

(51) Int. Cl. G06F 17/30

(52) U.S. Cl. 707/1

(57) ABSTRACT

A computing device is configured to provide personal information and communications functions. The computing device includes, among other things, a communication interface, a storage device, and a processor. The communication interface is adapted to pass at least one communication. The storage device is operably coupled to the communication interface, and stores a contact information database relative to at least one contact. The storage device also stores auto-association information relative to the at least one contact. The processor is coupled to the storage device and configured to detect an event relative to the communication. The processor analyzes the communication to ascertain communication contact information. A communication history item is automatically generated when the event is detected and the communication contact information corresponds with information in the contact information database that is indicated as auto-associated by the auto-association information.

### BACKGROUND OF THE INVENTION

Commercially available personal information management and communications programs provide a wealth of features to computer users. Such applications are known to provide an integrated solution for managing and organizing e-mail messages, schedules, tasks, notes, contacts, and other information. The integrated nature of the information and communication management of such applications allows users thereof to manage their information and communicate very efficiently. One example of such an application is sold under the trade designation Microsoft Office Outlook 2003, available from Microsoft Corporation of Redmond, Wash.

Known applications typically allow for management of e-mail, calendar and contact information all from within the same application. These applications can provide advanced categorization and search functionality for these various entities. For example known applications provides a feature where a user can view e-mail and calendar item interaction history. This feature is generally provided by allowing a user to select one or more folders on their local machine to monitor. The application will then provide an event notification when a selected event, such as an item being added or an item being modified, occurs within a monitored folder. When an event is detected, the item is evaluated to determine if it is an item for which the user has selected auto association with a contact. If so, a communications history link is created between the contact and the e-mail or calendar item. Once the e-mail/calendar item is linked to all appropriate contacts, a notification is generated in order to update any dynamic history views that the user may have open.

The features provided by known personal information and communication applications have proven extremely useful. In order to provide more effective use of such applications for multi-user collaboration, some additional features would be helpful. These and other features of embodiments of the present invention are set forth below.

### SUMMARY OF THE INVENTION

A computing device is configured to provide personal information and communications functions. The computing device includes, among other things, a communication interface, a storage device, and a processor. The communication interface is adapted to pass at least one communication. The storage device is operably coupled to the communication interface, and stores a contact information database relative to at least one contact. The storage device also stores auto-association information relative to the at least one contact. The processor is coupled to the storage device and configured to detect an event relative to the communication. The processor analyzes the communication to ascertain communication contact information. A communication history item is automatically generated when the event is detected and the communication contact information corresponds with information in the contact information database that is indicated as auto-associated by the auto-association information.

### BRIEF DESCRIPTION OF THE DRAWINGS

FIG. 1 is a block diagram of one computing environment in which the present invention may be practiced.

FIG. 2 is a block diagram of an alternative-computing environment in which the present invention may be practiced.

FIG. 3 is a flow diagram of a method of handling a communication in accordance with an embodiment of the present invention.

### DETAILED DESCRIPTION OF ILLUSTRATIVE EMBODIMENTS

While embodiments of the present invention will generally be described with respect to e-mail communications and the communication of calendar items, it is expressly noted that embodiments of the present invention are applicable to any communication that bears an identification (either in electronic form, or in a form that can be effectively digitized) of a sender.

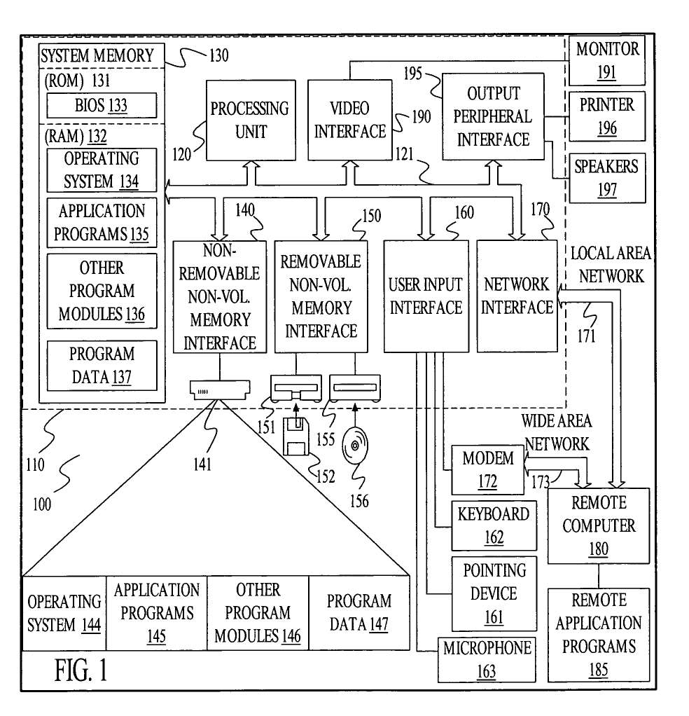

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

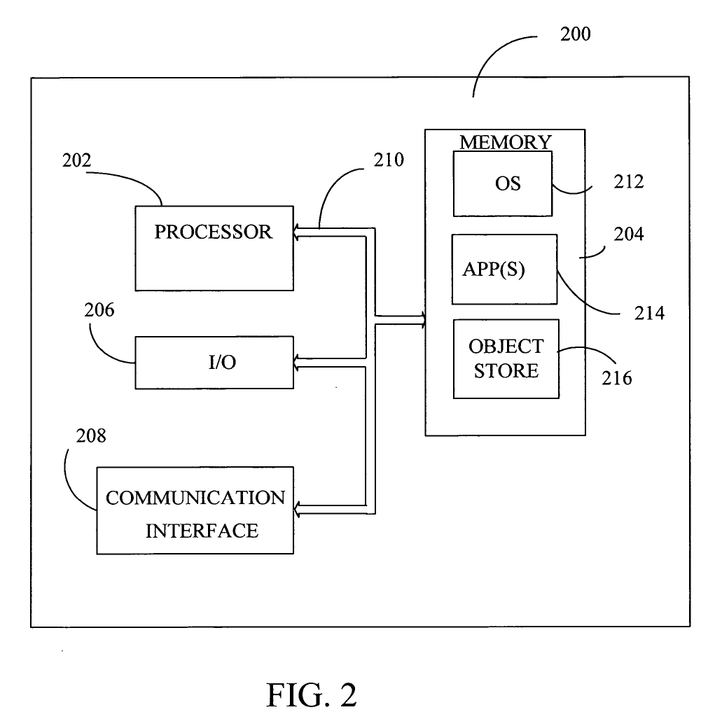

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

In accordance with one broad aspect of embodiments of the present invention, communications such as e-mails and calendar items are automatically associated with business contacts as such communications are sent or received. Then, when a user wishes to view the communication history of a particular contact, the communication history view is dynamically updated without requiring the user to perform complicated or repetitive global searches through the various forms of communication. In accordance with another broad aspect, the automatic association functionality is configurable on a per contact or per e-mail address setting for each user of the system.

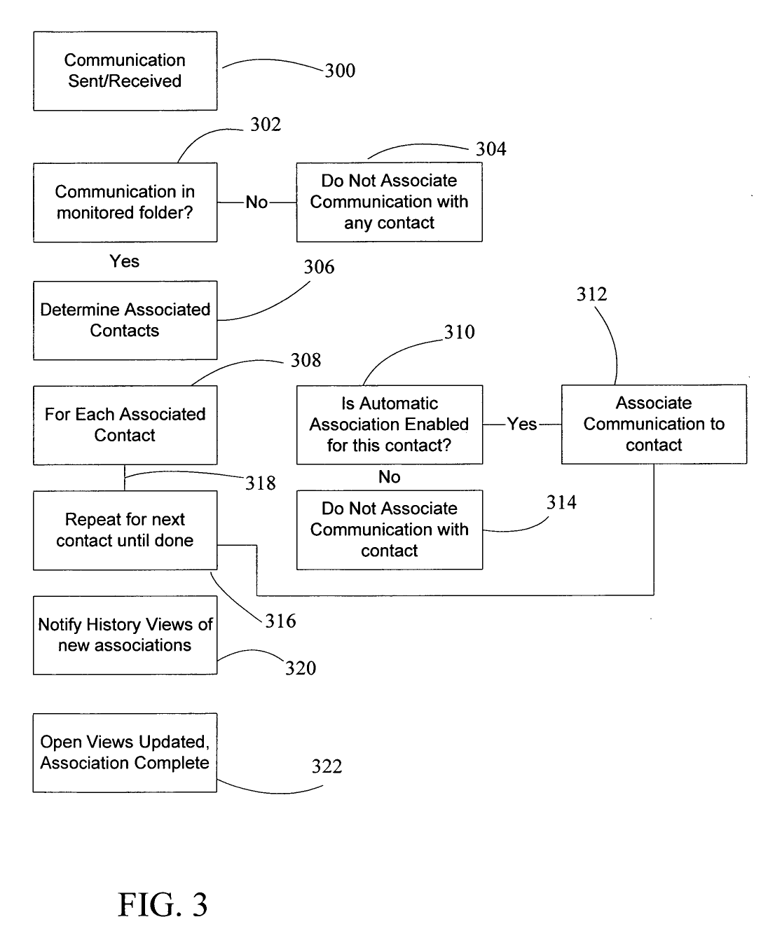

FIG. 3 is a flow diagram of a method of handling a communication in accordance with an embodiment of the present invention. The method begins at block 300 where a communication is sent or received. Exemplary communications include e-mail and calendar items. However, other forms of communication can be used. One example includes, a facsimile where the sender can be identified via caller ID information or determined from the text of the facsimile via optical character recognition (OCR). Yet another form of communication includes voice-mail where the sender is identifiable via caller ID.

The method continues at block 302 where the BCM module of the application determines if the communication is in a monitored folder. For example, Outlook 2003 currently has an “in-box” folder. If incoming e-mail for any contact is to be monitored, the application subscribes to the Outlook event notification for items being added to the “in-box” folder. Then, when an e-mail is received, Outlook provides an event notification to the subscriber that the subscribed event has occurred. If the communication is not in a monitored folder, flow passes to block 304, where the communication is not associated with any contact. If, however, the communication is in a monitored folder, control passes to block 306 where the communication is analyzed to determine communication contact information. For example, in instances where the communication is an e-mail, the e-mail is opened and the addresses in the “to” line, the “from” line and the “cc” line are checked to see who all the potential contacts are who would be touched by the e-mail. These addresses are examples of communication contact information and are used to build a list of senders and recipients. The list is preferably normalized. One form of normalization includes normalizing the e-mail addresses to simple mail transfer protocol (SMTP) form. The normalized list is then used to query a list of contact items (such as business contact or account) that have at least one of matching piece of contact information. Where the communication is an e-mail, the list of e-mail addresses is used to query a list of contact items that have at least one of the e-mail addresses as a value in their e-mail data field(s). This will generate a list of pairs of e-mail address/contact items. At block 308, a loop is performed for each identified contact. Specifically, blocks 310 and 312 or 314 are performed for each pair in the list. At block 310, for a specific contact, the contact is checked to determine if automatic association of the communication is enabled. This can be accomplished by consulting a user-generated list. The list may indicate that a specific contact, or specific sub-contact, is enabled for automatic association. If enabled, block 312 executes, where the contact is marked as a target for association of the communication. A communication history link is then created between the contact and the communication. It is preferable that the history link include a summary of information relative to the communication. If auto-association is not enabled, control passes from block 310 to block 314, where the communication is not associated with the contact.

At block 316, the process is repeated for each contact by returning control to block 308 through line 318, until all contacts have been processed. Once all contacts have been processed, control passes from block 316 to block 320, where history view notifications are generated. On the local machine, generating a notification simply includes providing a notification to the Outlook application that contacts, represented as messaging application programming interface (MAPI) objects, have been updated.

At block 322, all open history views are automatically updated with the latest communications. Thus, if a user has selected the contact Joe Smith for auto-association, and an e-mail arrives from Joe Smith while the user is viewing Joe's communication history, the history view will be updated with the new e-mail.

Generating the notifications in a multi-user environment is somewhat more complex. For multi-user embodiments, change records are inserted into the local machine's shared database, and a polling mechanism on one or more remote machines is used to detect the change records. If the remote machine's polling observes a change record in the shared database, the change record is then converted on the remote machine to a local (for the remote machine) Outlook notification event, corresponding to the change record. In this manner, all history views that correspond to a shared contact, will be updated when a communication for that contact arrives.

One advantageous feature of embodiments of the present invention is the ability to auto-associate different aspects of a contact differently. For example, a given contact may have a plurality of e-mail addresses, and use one e-mail address for the transmission of sensitive materials. In a multi-user environment, it is important that the level of sharing be configurable. Thus, the contacts less sensitive e-mail addresses may be auto-associated and shared, while the sensitive address, while auto-associated, is not shared among users. Accordingly, each user of the Business Contact Manager portion of the personal information and communications software will generate their own list of contacts and/or sub-contact information (such as specific e-mail addresses) for auto-association. Additionally, each user's auto-association list allows that user to configure whether the particular auto-association is shared, and if so, how it is shared among other users. Further, each user can preferably only modify their own auto-association information. This allows for maintaining privacy of communications, where necessary, while providing visibility of communications among multiple users where desired/appropriate. Finally, it is preferred that when the product is first provided to a user, that all contacts are initially set to no auto-association. Thus, a user must affirmatively engage the auto-association features in order to use them.

Although the present invention has been described with reference to particular embodiments, workers skilled in the art will recognize that changes may be made in form and detail without departing from the spirit and scope of the invention.

What is claimed is:

1. A local computing device configured to provide personal information and communications functions, the computing device comprising:
a communication interface adapted to pass at least one communication;
a storage device operably coupled to the communication interface, the storage device storing a contact information database relative to at least one contact and storing auto-association information relative to the at least one contact;
a processor coupled to the storage device and configured to detect an event relative to the communication, the processor being further configured to analyze the communication to ascertain communication contact information; and
wherein a communication history item is automatically generated when the event is detected and the communication contact information corresponds with information in the contact information database that is indicated as auto-associated by the auto-association information.

2. The device of claim 1, wherein the processor is further adapted to generate a notification event to an open view relative to the contact.

3. The device of claim 2, wherein the notification event is a local notification event.

4. The device of claim 2, wherein the notification event is generated on a remote computing device.

5. The device of claim 4, wherein at least one change record is stored on the local computing device, and the remote computing device is adapted to poll the local computing device.

6. The device of claim 4, wherein the remote computing device generates a local, relative to the remote computing device, notification to an open history view relative to the contact.

7. The device of claim 1, wherein the local computing device is a desktop computer.

8. The device of claim 1, wherein the local computing device is a mobile computing device.

9. The device of claim 1, wherein the communication is an e-mail.

10. The device of claim 1, wherein the communication is a calendar item.

11. The device of claim 1, wherein the auto-association information is user-specific, allowing each user to create their own auto-associations.

12. The device of claim 11, wherein each user can only modify their own auto-associations.

13. The device of claim 1, wherein the auto-association information includes sub-contact information.

14. The device of claim 1, wherein the sub-contact information includes at least one e-mail address.

15. The device of claim 1, wherein the event is the placing of the communication in a monitored folder.

16. The device of claim 1, wherein the processor normalizes the communication contact information.

17. The device of claim 16 wherein the normalization includes converting the communication contact information to simple mail transfer protocol.

18. A method of processing an electronic communication, the method comprising:
detecting an event relative to the communication;
analyzing the communication to extract communication contact information;
comparing the communication contact information with information stored in a contact database to find a contact that corresponds to the communication contact information;
consulting auto-association information to determine if the communication is enabled for auto-association; and
selectively auto-associating the communication.

19. The method of claim 18, wherein selectively auto-associating the communication further comprises generating a notification that automatically updates a history view that is open relative to the contact.

20. The method of claim 18, wherein the auto-association information is user-specific.

21. The method of claim 18, wherein the event corresponds to the reception of the communication.

22. The method of claim 18, wherein the event corresponds to the transmission of the communication.

23. The method of claim 18, and further comprising generating a change record indicative of the communication.

24. The method of claim 23, and further comprising polling a computing device to detect the change record, and generating a notification indicative of the change record.
